(19) United States
(12) Patent Application Publication
(10) Pub. No.: US 2014/0231486 A1
(43) Pub. Date: Aug. 21, 2014

(54) STAPLER

(71) Applicant: Milwaukee Electric Tool Corporation, Brookfield, WI (US)

(72) Inventors: Wade F. Burch, Wauwatosa, WI (US); Michael S. Steele, Waukesha, WI (US); Steven W. Hyma, Milwaukee, WI (US)

(21) Appl. No.: 14/184,223

(22) Filed: Feb. 19, 2014

Related U.S. Application Data
(60) Provisional application No. 61/766,433, filed on Feb. 19, 2013.

(51) Int. Cl. B25C 5/06; B25C 5/11; B25C 11/00

(52) U.S. Cl. CPC B25C 5/06; B25C 11/00; B25C 5/11
USPC 227/63; 227/140; 227/147

(57) ABSTRACT

A stapler may generally include a main body having a front side and a bottom side extending from the front side, a staple discharge opening being defined on the bottom side proximate the front side; and a staple puller projecting from the front side.

### CROSS-REFERENCE TO RELATED APPLICATION

This application claims priority to co-pending U.S. Provisional Patent Application No. 61/766,433, filed Feb. 19, 2013, the entire content of which is incorporated herein by reference.

### FIELD

The present invention generally relates to staplers, such as hand staplers and hammer tackers.

### SUMMARY

Staplers are typically used to fasten two or more objects together. Hand staplers and hammer tackers are two types of commonly-used staplers. Hand staplers typically include a main body and an actuating lever pivotally coupled to the main body. To fire a staple, a user squeezes that actuating lever towards the main body. The actuating lever actuates an internal driving mechanism that drives a single staple into a workpiece. Hammer tackers typically include a head, a handle extending from the head, and an actuator or shoe located on the head. To fire a staple, a user grips the handle and swings the hammer tacker, similar to a hammer. When the shoe contacts a work-piece, the shoe actuates a driving mechanism that drives a single staple into the workpiece.

In one independent embodiment, a stapler may generally include a main body having a front side and a bottom side extending from the front side, a staple discharge opening being defined on the bottom side proximate the front side; and a staple puller projecting from the front side.

In another independent embodiment, a stapler may generally include a main body having a front side and a bottom side extending from the front side, a staple discharge opening being defined on the bottom side proximate the front side; and a chamfer connecting the front side and the bottom side and located adjacent the staple discharge opening.

In yet another independent embodiment, a stapler may generally include a main body having a front side, a back side and a bottom side extending between the front side and the back side, a staple discharge opening being defined on the bottom side proximate the front side; and a hammer surface located on the back side.

Other independent features and independent aspects of the invention will become apparent by consideration of the following detailed description, claims, and accompanying drawings.

### BRIEF DESCRIPTION OF THE DRAWINGS

FIG. 1 is a perspective view of a stapler according to one independent embodiment.

FIG. 2 is a front view of the stapler of FIG. 1.

FIG. 3 is a top view of the stapler of FIG. 1.

FIG. 4 is a bottom view of the stapler of FIG. 1.

FIG. 5 is a left side view of the stapler of FIG. 1.

FIG. 6 is a right side view of the stapler of FIG. 1.

FIG. 7 is a rear view of the stapler of FIG. 1.

FIG. 8 is a cross-sectional view of the stapler, taken generally along line 8-8 in FIG. 1.

FIG. 8A is a cross-sectional view of the stapler, taken generally along line 8A-8A in FIG. 1.

FIG. 9 is a cross-sectional view of the stapler of FIG. 8 just before being fired.

FIG. 10 is a cross-sectional view of the stapler of FIG. 8 after being fired.

FIG. 11 is a perspective view of a stapler according to another independent embodiment.

FIG. 12 is a front view of the stapler of FIG. 11.

FIG. 13 is a top view of the stapler of FIG. 11.

FIG. 14 is a bottom view of the stapler of FIG. 11.

FIG. 15 is a left side view of the stapler of FIG. 11.

FIG. 16 is a right side view of the stapler of FIG. 11.

FIG. 17 is a rear view of the stapler of FIG. 11.

FIG. 18 is an enlarged perspective view of a portion of the stapler of FIG. 11.

FIG. 19 is a cross-sectional view of the stapler, taken generally along line 18-18 in FIG. 11.

FIG. 20 is a cross-sectional view of the stapler of FIG. 19 after being fired.

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways.

### DETAILED DESCRIPTION

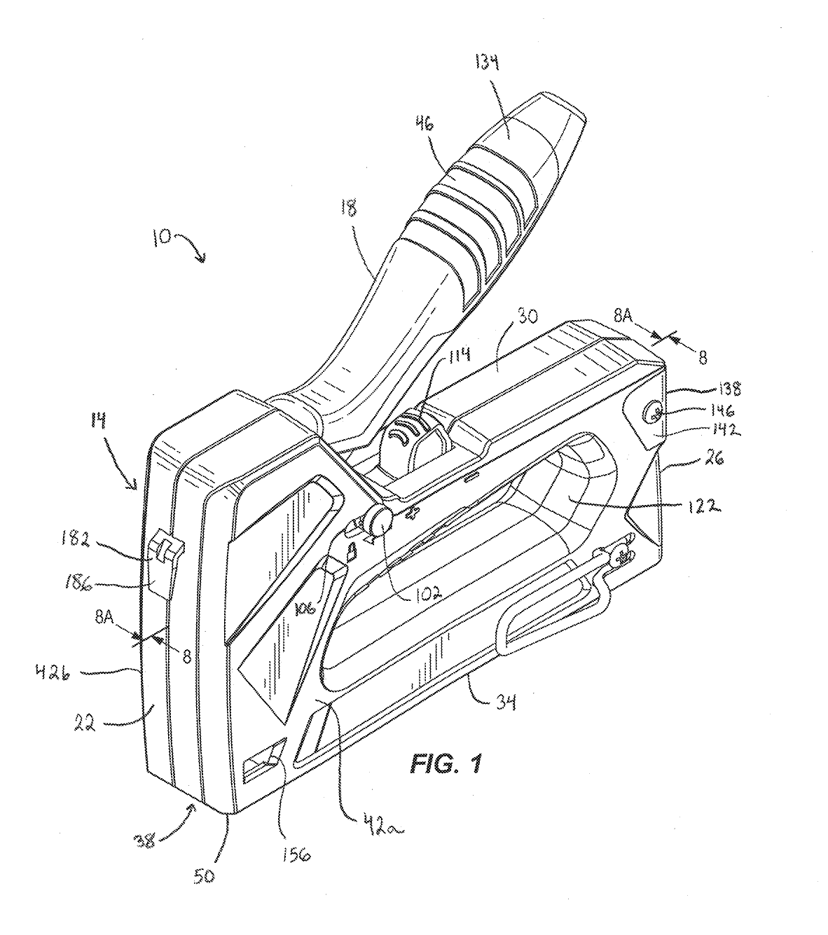

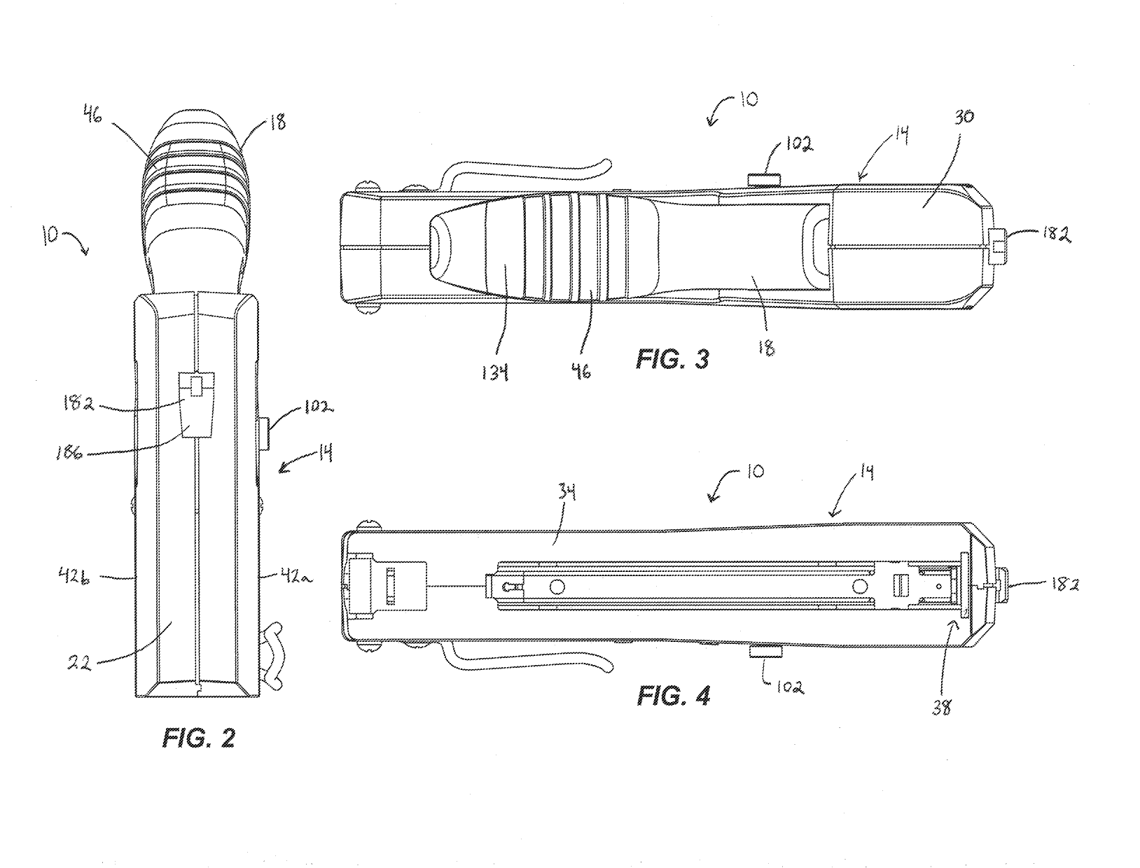

FIGS. 1-10 illustrate a stapler 10 according to one independent embodiment. The illustrated stapler 10 is a hand stapler or staple gun. The stapler 10 includes a main body 14 and an actuator lever 18 pivotally coupled to the main body 14. The main body 14 has a front side 22 (FIG. 2), a back side 26 (FIG. 7), and top and bottom sides 30, 34 (FIGS. 3 and 4) extending between the front side 22 and the back side 26. A staple discharge opening 38 is located on the bottom side 34, generally adjacent the front side 22.

In the illustrated embodiment, the main body 14 includes two cooperating halves 42a, 42b that may be secured together by fasteners or in any other suitable manner. The main body 14 may be made of a polymeric material (e.g., impact-resistant plastic), metal, or a combination thereof. The illustrated actuator lever 18 includes an overmolded rubber grip 46 that provides a user with an ergonomic surface to grip the lever 18.

A chamfer 50 or angled surface connects the front side 22 and the bottom side 34 of the main body 14. The chamfer 50 may improve seating of a fired staple into a workpiece and minimize the chances that the staple will extend an undesirable distance above the workpiece after being fired. Also, the chamfer 50 may compensate for a user's inability to hold the stapler 10 precisely flush to the workpiece.

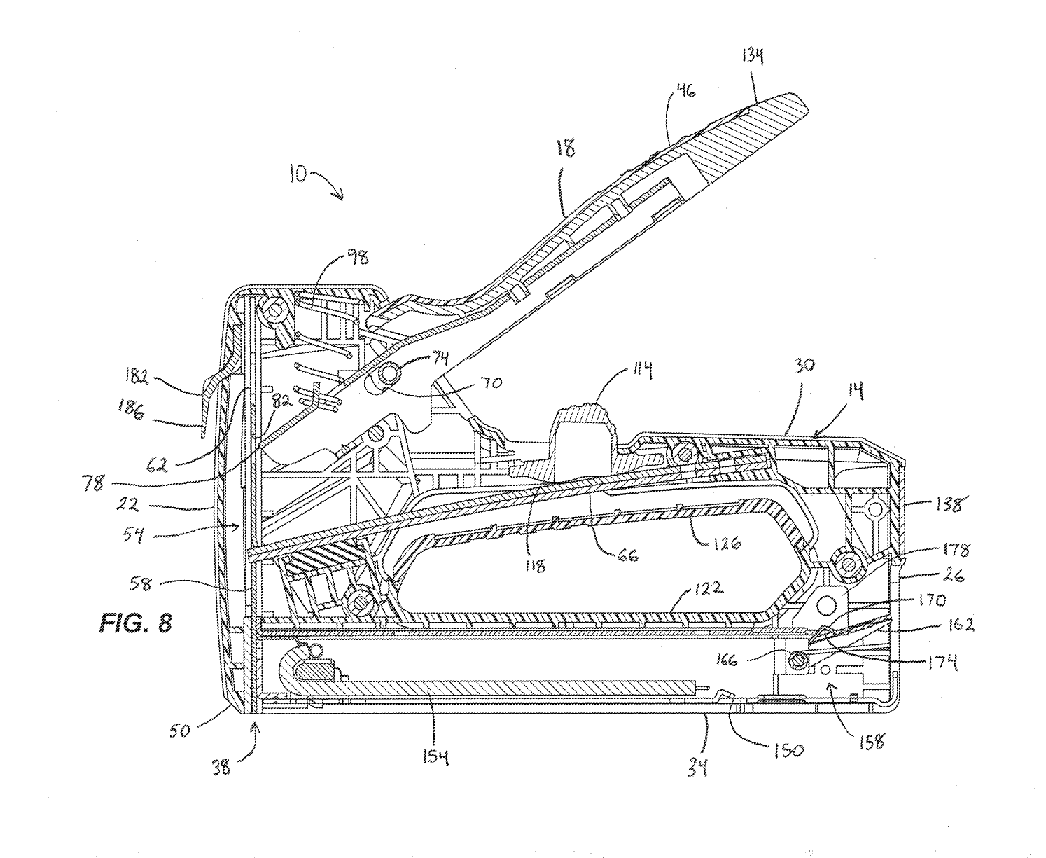

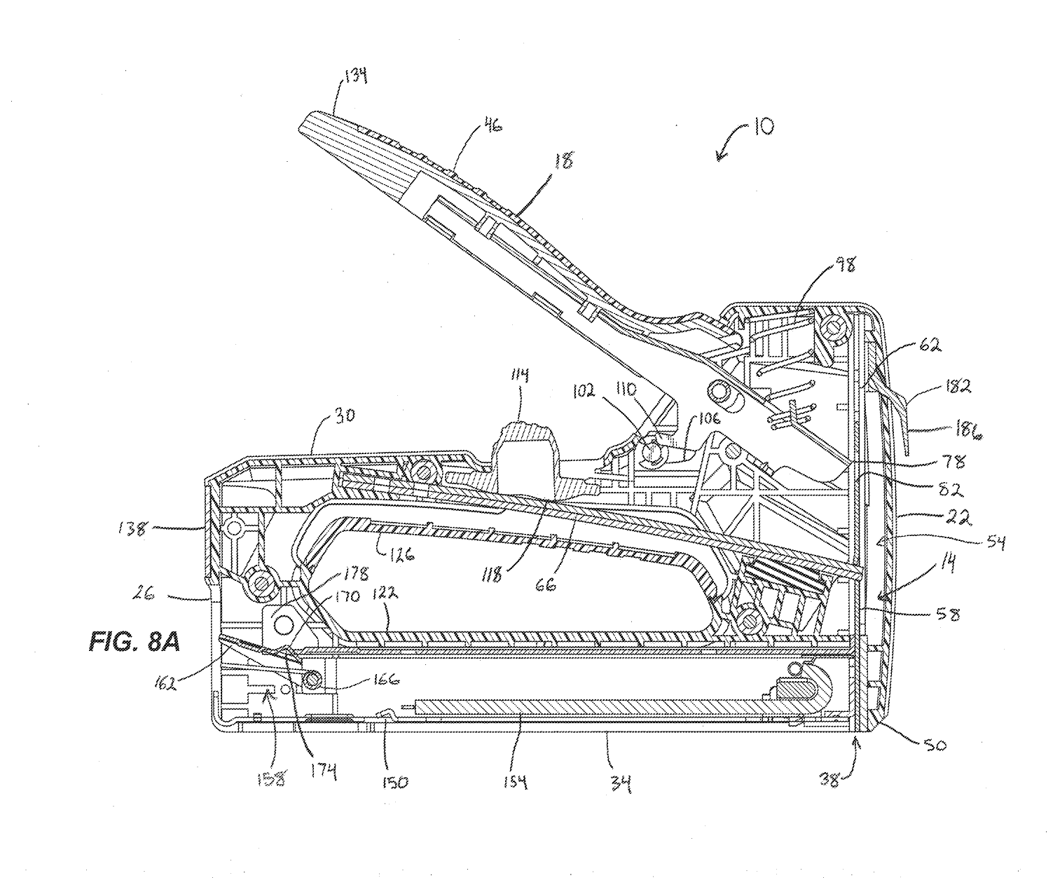

With reference to FIG. 8, the stapler 10 includes a firing mechanism 54 operable to eject a staple through the discharge opening 38 in response to pivotal movement of the actuator lever 18 towards the main body 14. The firing mechanism 54 includes a plunger 58 slidable along a drive track 62 within the main body 14, and a power spring 66 engaged with the plunger 58. In the illustrated embodiment, the power spring 66 includes a pair of leaf springs or bar springs. The actuator lever 18 includes an elongated slot 70 that receives a pin 74 fixed to the main body 14 to pivotally couple the lever 18 to the body 14.

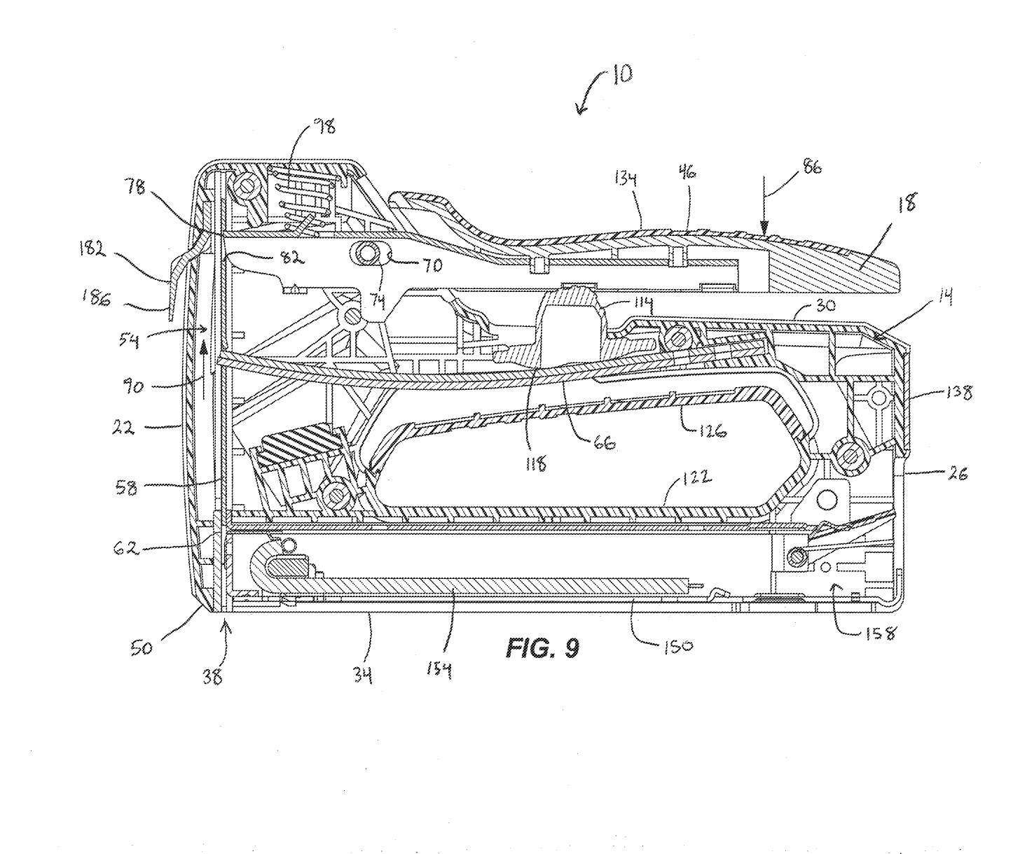

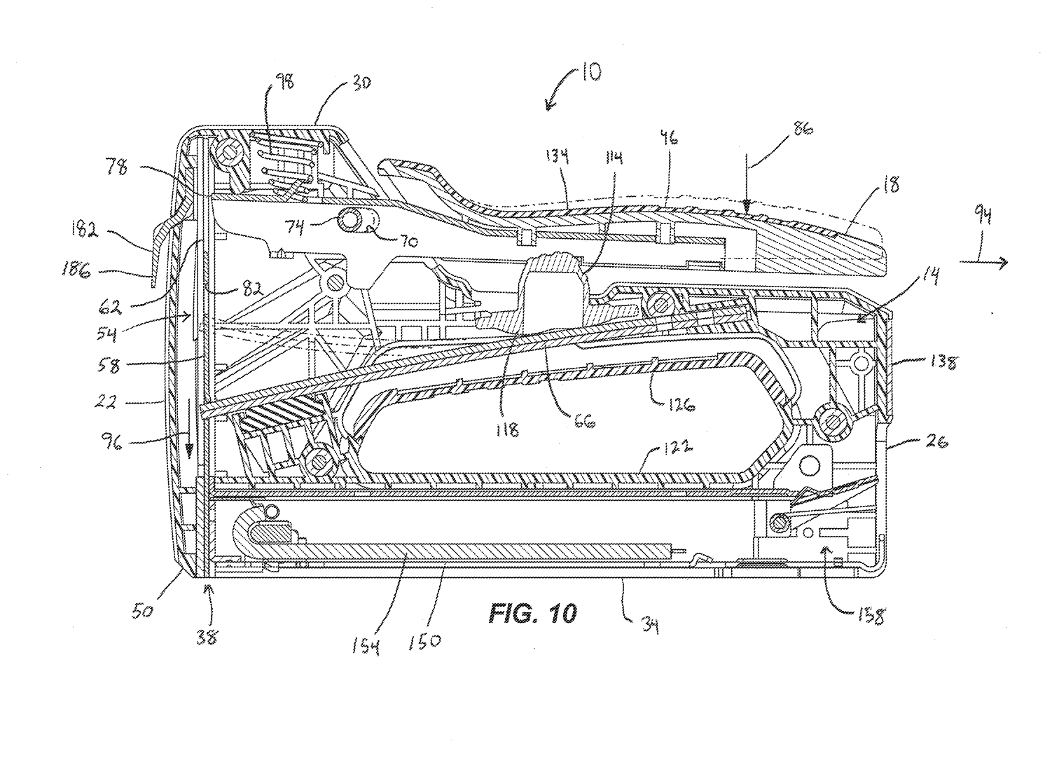

In a neutral position of the lever 18 (illustrated in FIG. 8), a distal tip 78 of the lever 18 is received by an aperture 82 in the plunger 58. To fire a staple, the actuator lever 18 is pivoted downwardly, toward the top side 30 of the main body 14. As the lever 18 pivots in the direction of arrow 86, the distal tip 78 lifts the plunger 58 in the direction of arrow 90, against the biasing force of the power spring 66 (FIG. 9). When the actuator lever 18 reaches a generally horizontal position (illustrated in FIG. 9) continued pressure on the lever 18 in the direction of arrow 86 causes the lever 18 to slide to an actuated position (FIG. 10) in the direction of arrow 94, with the pin 74 sliding along the elongated slot 70. This sliding movement disengages the distal tip 78 from the aperture 82 in the plunger 58, thereby releasing the plunger 58 to fire a single staple in the direction of arrow 96. A return spring 98 biases the actuator lever 18 back towards the neutral position to reset the stapler 10.

With reference to FIGS. 1 and 8A, the stapler 10 further includes a lock 102 supported in a slot 106 in the main body 14. When the actuator lever 18 is in the actuated position (FIG. 10), the lock 102 can be slid along the slot 160 and into engagement with a hook 110 (FIG. 8A) on the underside of the lever 18 to prevent the lever 18 from returning to the neutral position.

A power switch 114 is operable to vary the driving force of the stapler 10 by adjusting the spring force of the power spring 66. In the illustrated embodiment, the power switch 114 is a slidable switch having a curved lower surface 118 that acts as the pivot point for the power spring 66 when the plunger 58 is lifted. The power switch 114 is movable relative to the main body 14 between a low power position (illustrated in FIGS. 8-10), in which the pivot point is furthest away from the plunger 58 to provide a relatively low spring force, and a high power position, in which the pivot point is closest to the plunger 58 to provide a relatively high spring force.

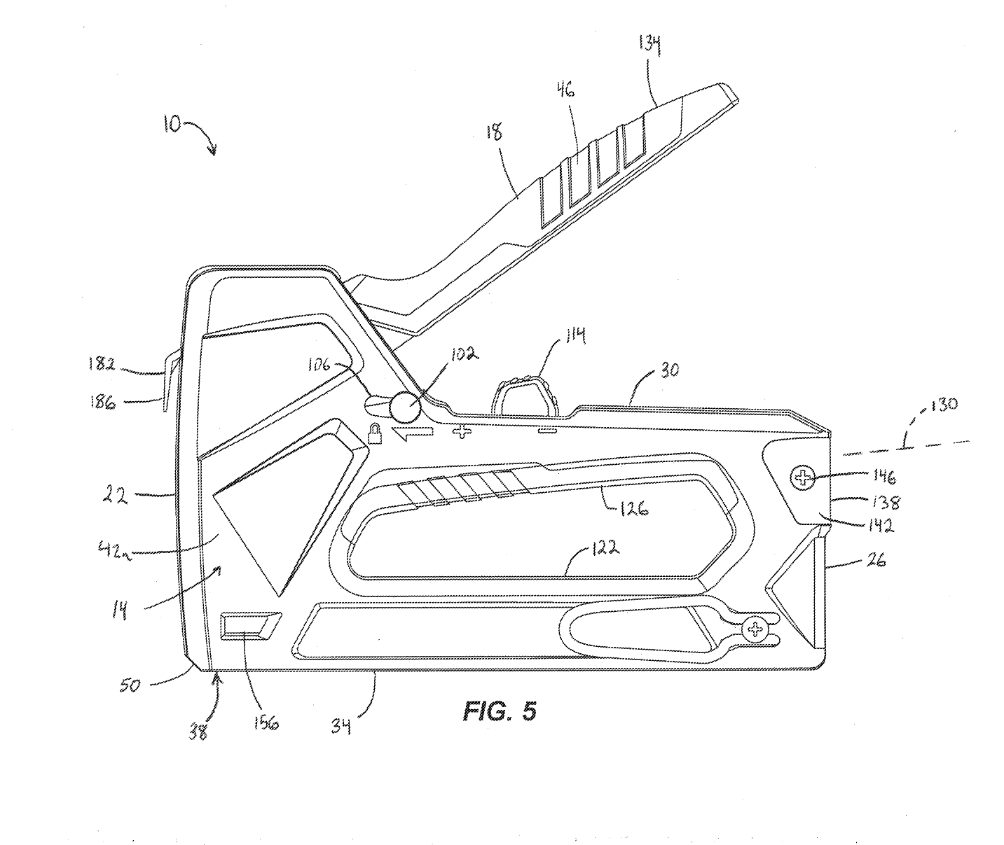

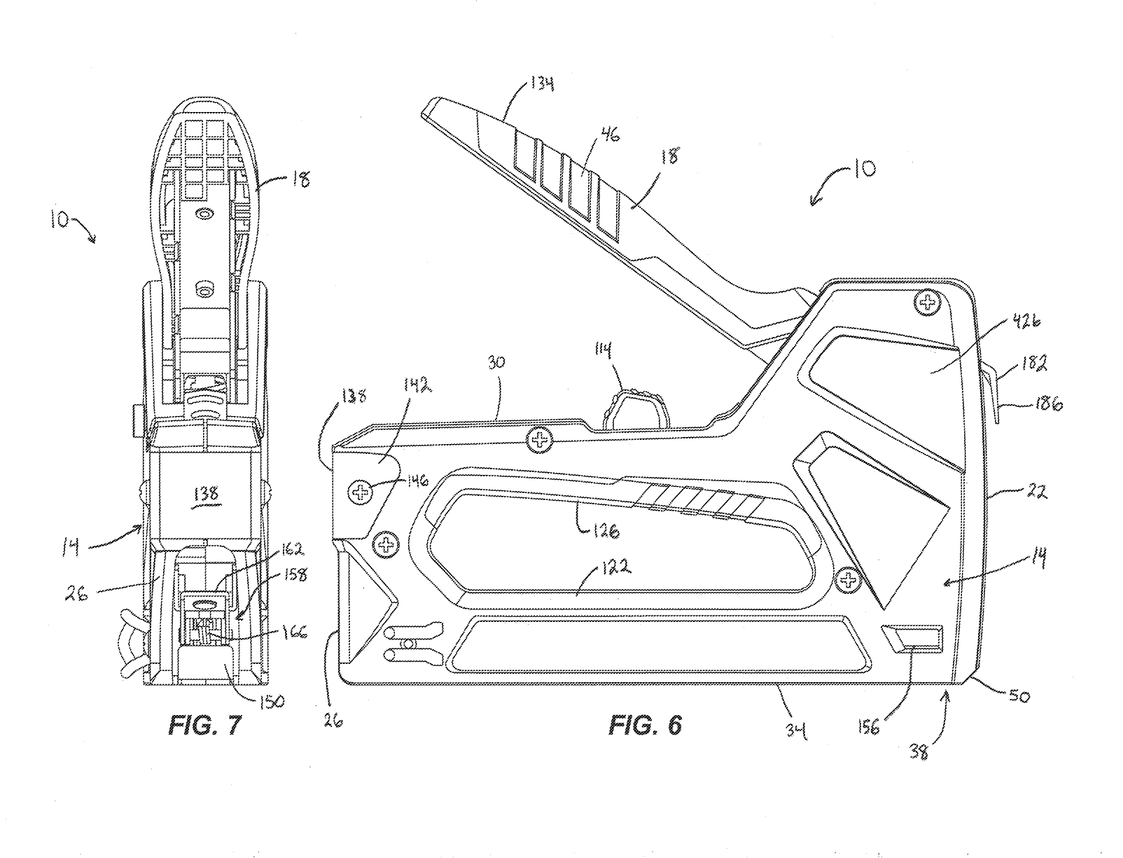

Referring to FIGS. 5 and 6, the main body 14 includes a grip aperture 122. The user places his or her fingers through the grip aperture 122 with his or her palm on the actuator lever 18 to press the lever 18 to operate the stapler 10. The grip aperture 122 includes an upper surface 126 that angles upwardly in a direction from the front side 22 to the back side 26, as represented by an axis 130 (FIG. 5). The angled upper surface 126 minimizes the distance between the top side 30 of the body 14 and the upper surface 126 of the grip aperture. Accordingly, the distance between a top surface 134 of the lever 18 and the upper surface 126 of the grip aperture 122 is also minimized. By reducing or minimizing these distances, it may be easier for the user to actuate the lever 18 because the user's fingers and palm do not need to span as great a distance.

With reference to FIGS. 5-7, the stapler 10 includes a hammer surface 138 located on its back side 26. In the illustrated embodiment, the hammer surface 138 is formed by a generally U-shaped bracket 142 coupled to the main body 14 (e.g., by fasteners 146). As such, the bracket 142 may be removed and replaced should the hammer surface 138 become worn or damaged. The hammer surface 138 can be used to further pound in staples that were not fully embedded in the workpiece during normal operation. The hammer surface 138 can be formed from metal or another hard material whereas other portions of the body 14 may be formed of and/or covered by a polymeric material, such as rubber.

Referring again to FIG. 8, the stapler 10 includes a removable magazine 150 configured to receive and store a line of staples. An internal biasing mechanism 154 feeds the staples toward the plunger 58 as individual staples are ejected during operation. In the illustrated embodiment, a window 156 is located adjacent the front side 22 (FIG. 1). The window 156 allows the user to easily visually recognize whether there are staples in the magazine 150 and when the stapler 10 is about to run out of staples. An indicator (e.g., a label) may be provided on the side of the body 14 to indicate the size or sizes of staples that can be used with the stapler 10.

The magazine 150 is retained in position within the main body 14 by a latch mechanism 158. The latch mechanism 158 includes an actuator 162 pivotally coupled to the body of the magazine 150 and biased into a latched position (illustrated in FIG. 8) by a torsion spring 166 supported on the magazine 150. A tab 170 on the actuator 162 is received within an aperture 174 of a bracket 178 fixed to the main body 14 to lock the magazine 150 in place.

To remove the magazine 150, a user presses down or pinches the actuator 162 to compress the spring 166 and disengage the tab 170 from the aperture 174. The magazine 150 can then be slidably withdrawn from the main body 14. When the magazine 150 is reinserted into the main body 14, the front side of the tab 170 acts as a cam surface to deflect the actuator 162 away from the bracket 178 until the tab 170 is aligned with the aperture 174.

With reference to FIG. 1, a staple puller 182 is located on the front side 22 of the main body 14, generally adjacent to and in-line with the drive track 62 (in the illustrated embodiment). The staple puller 182 extends into main body 14 and is secured between the two halves 42a, 42b. The illustrated staple puller 182 includes a claw shaped member 186 that can be used to pry a staple from a workpiece. In the illustrated embodiment, the front side 22 of the body 14 is curved to provide a fulcrum for the staple puller 182. Alternatively, a fulcrum point can be provided by a protrusion on the front side 22. In one embodiment, the front side 22 can include rubber or other resilient or soft material to inhibit marring or marking of the workpiece when the staple puller 182 is utilized.

In operation, the user grips the stapler 10 through the grip aperture 122 and depresses the actuator lever 18 towards the top side 30 of the main body 14. The actuator lever 18 actuates the firing mechanism 54 to drive a single staple into the workpiece. The magazine 150 then advances the next staple into position to be driven. If necessary, the user may turn the stapler 10 upside down and strike the staple with the hammer surface 138 to further pound the staple into the workpiece. Additionally, if the user desires to remove the staple from the workpiece, the user can wedge the claw shaped member 186 of the staple puller 183 between the staple and the workpiece, and then pry the staple out of the work piece, using the front side 22 as a fulcrum.

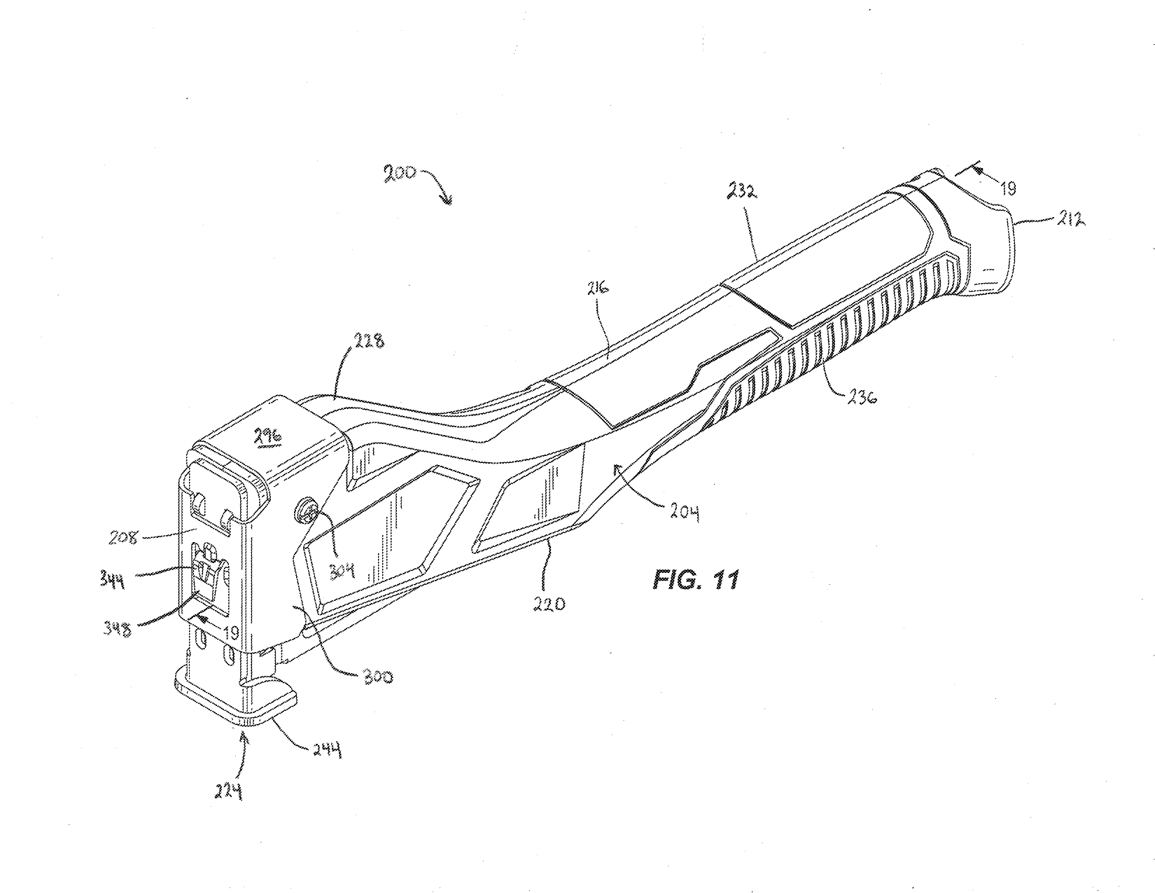

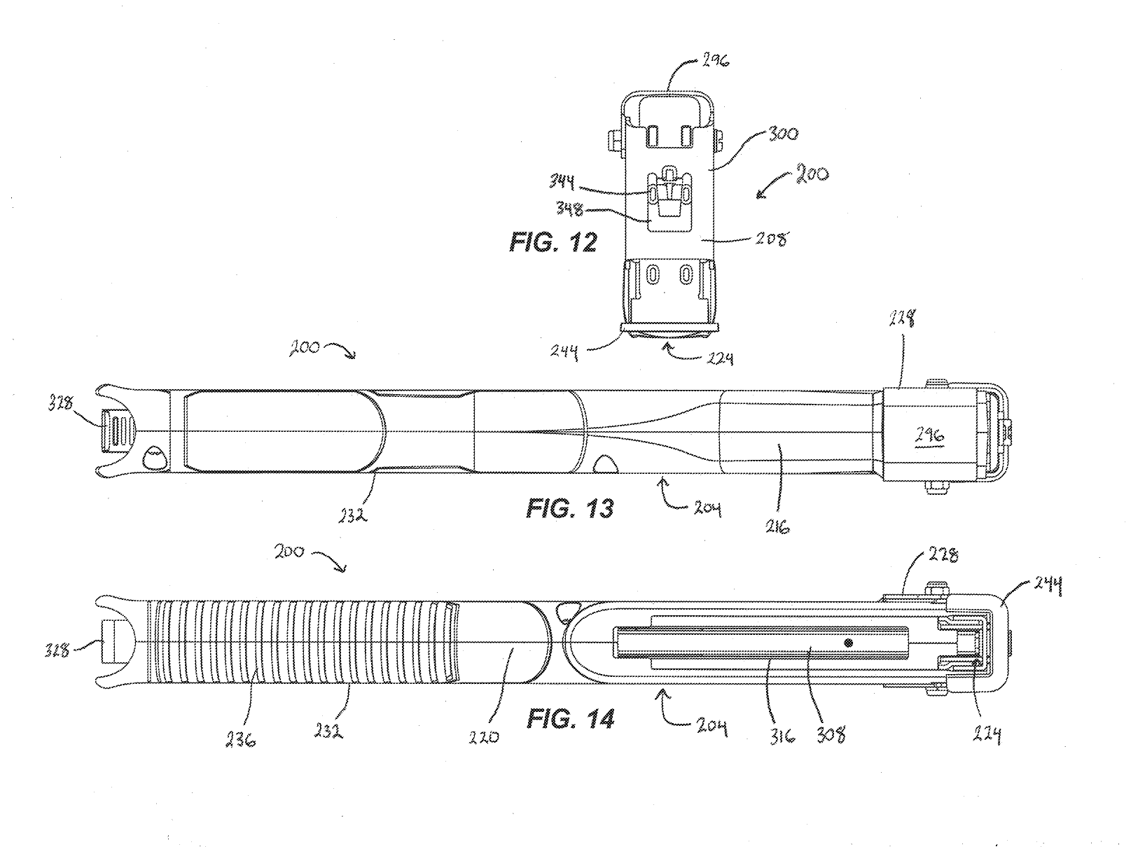

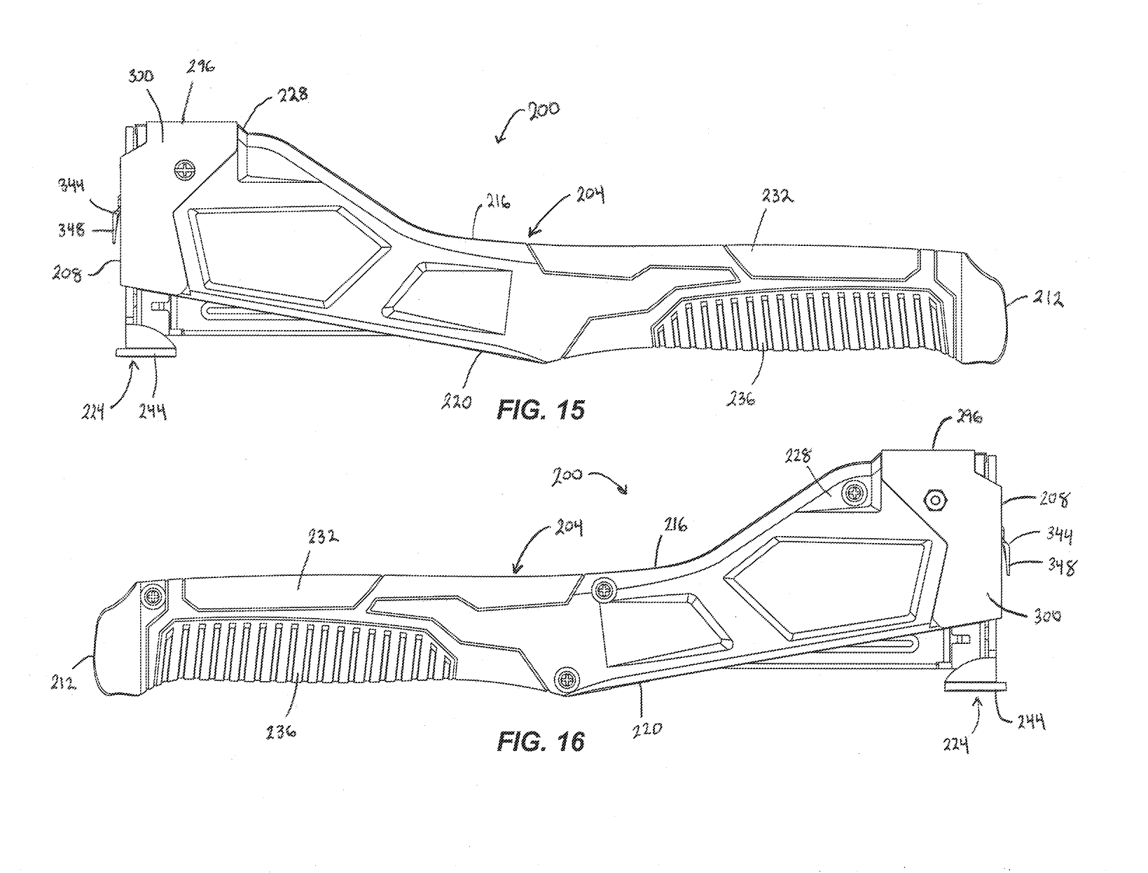

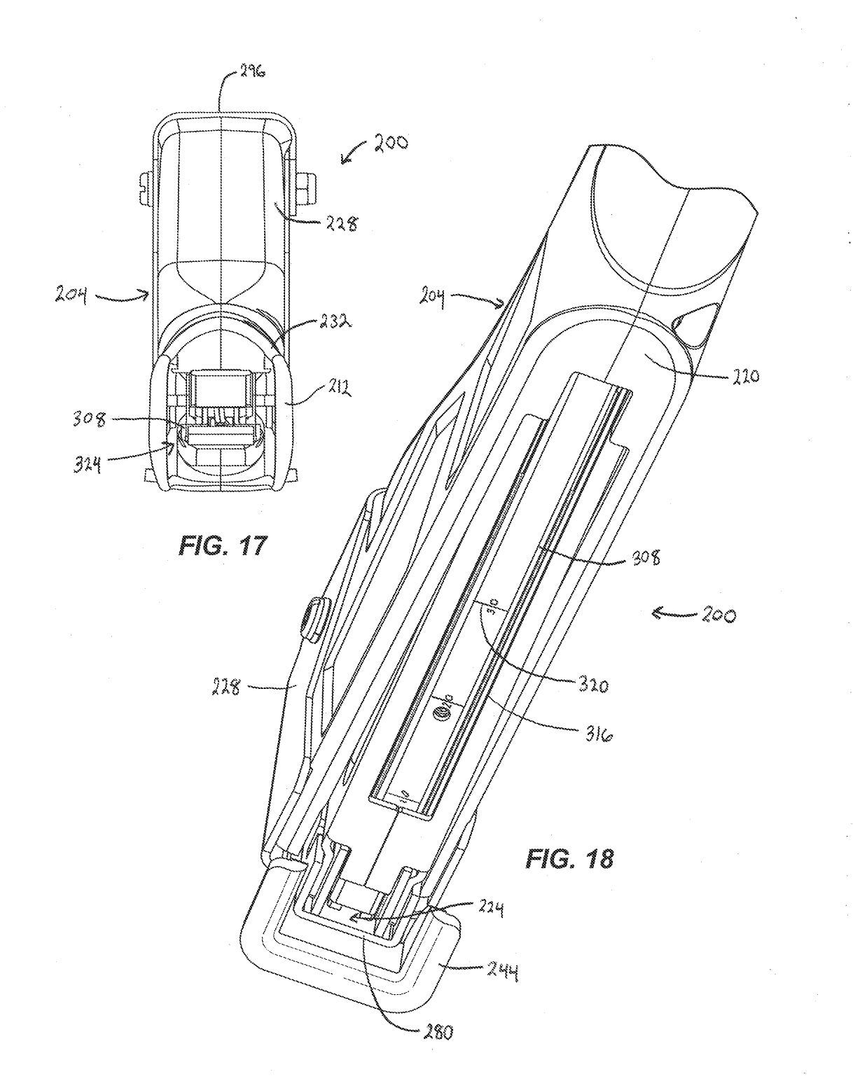

FIGS. 11-20 illustrate a stapler 200 according to another independent embodiment. The stapler 200 in this illustrated embodiment is a hammer stapler or hammer tacker with which the user swings the stapler 200, similar to a hammer, to discharge a staple. The stapler 200 includes a main body 204 having a front side 208 (FIG. 12), a back side 212 (FIG. 17), and top and bottom sides 216, 220 (FIGS. 13 and 14) extending between the front side 208 and the back side 212. A staple discharge opening 224 is located on the bottom side 216, generally adjacent the front side 208. The main body 204 includes a head 228 and a handle 232 extending from the head 228. The illustrated handle 232 has an ergonomic grip 236 that may provide a user with a comfortable place to grip the handle 232. In some embodiments, the grip 236 is made of overmolded rubber.

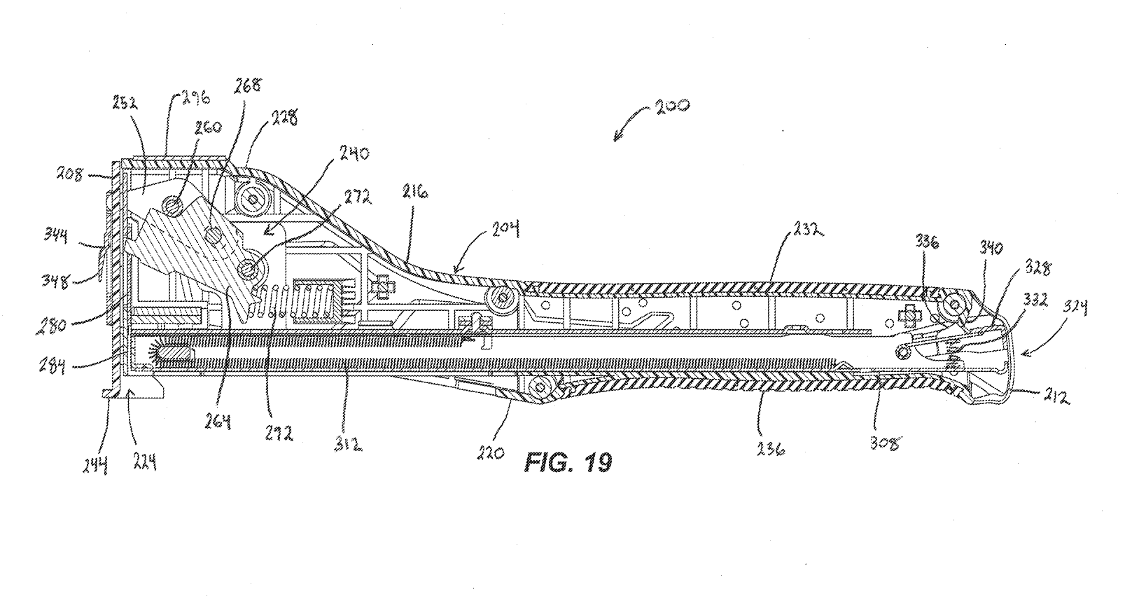

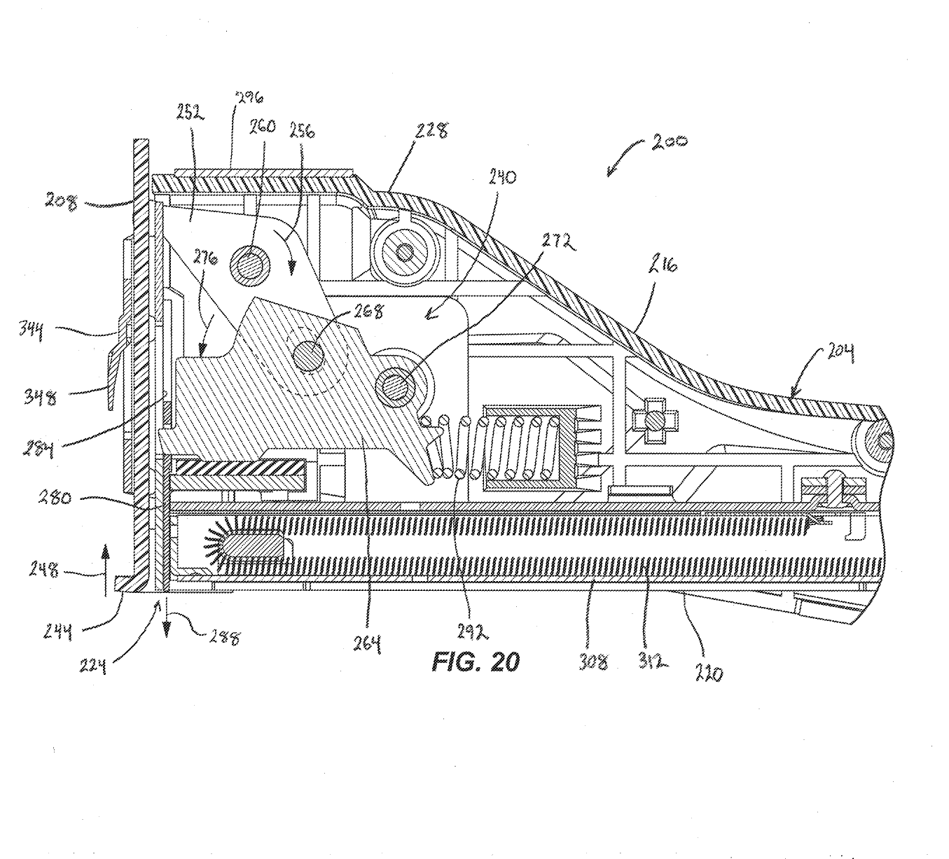

Referring to FIGS. 19 and 20, the stapler 200 includes a firing mechanism 240 operable to eject a staple through the discharge opening 224. The firing mechanism 240 includes a rounded shoe 244 engageable with a workpiece during a fastening operation. When the shoe 244 engages the workpiece (i.e. during an impact), the shoe 244 moves vertically upward, in the direction of arrow 248 (FIG. 20).

A first plate 252 is coupled to the shoe 244 such that upward movement of the shoe 244 causes the first plate 252 to pivot clockwise (in the direction of arrow 256) about a first pivot pin 260. The first plate 252 is coupled to a second plate 264 by a link pin 268 such that clockwise rotation of the first plate 252 causes the second plate 264 to rotate about a second pivot pin 272 in a counter-clockwise direction (in the direction of arrow 276). At one end, the second plate 264 is coupled to a plunger or knife 280, which slides along a drive track 284 in the direction of arrow 288 to eject a single staple through the discharge opening 224. At another end, the second plate 264 engages a return spring 292, which biases the firing mechanism 240 back to its neutral position (FIG. 19).

With reference to FIG. 11, the stapler 200 includes a hammer surface 296 located on the top side 216 of the head 228. In the illustrated embodiment, the hammer surface 296 is formed by a bracket 300 coupled to the head 228 (e.g., by fasteners 304). As such, the bracket 300 may be removed and replaced should the hammer surface 296 become worn or damaged. The hammer surface 296 can be used to further pound in staples that were not fully embedded in the work-piece during normal operation. The hammer surface 296 can be formed from metal or another hard material whereas other portions of the body 204 may be formed of and/or covered by a polymeric material, such as rubber. The stapler 200 can be configured so that the stapler 200 does not discharge a staple from the magazine when the hammer surface 296 is utilized, which has been found to be a problem when striking known hammer staplers on the top surface.

Referring to FIG. 19, the stapler 200 includes a removable magazine 308 slidably received within the handle 232 and configured to receive and store a line of staples. An internal biasing mechanism 312 feeds the line of staples toward the plunger 280 as individual staples are ejected during operation. Illustrated in FIG. 18, the magazine 308 includes a window 316 extending through its bottom side. The window 316 allows the user to easily visually recognize whether there are staples in the magazine 308 and when the stapler 200 is about to run out of staples. The illustrated magazine 308 also includes indicia 320 that are visible through the window 316 and to indicate of the quantity of staples remaining in the magazine 308.

The magazine 308 is retained in position within the handle 232 by a latch mechanism 324. The latch mechanism 324 includes an actuator 328 pivotally coupled to the magazine 308 and biased into a latched position (illustrated in FIG. 19) by a coil spring 332 supported on the magazine 308. A tab 336 on the actuator 328 engages a projection 340 inside the handle 232 to lock the magazine 308 in place.

To remove the magazine 308, the user presses down or pinches the actuator 328 to compress the spring 332 and disengage the tab 336 from the projection 340. The magazine 308 can then be slidably withdrawn from the handle 232. When the magazine 308 is reinserted into the handle 232, the front side of the tab 336 acts as a cam surface to deflect the actuator 328 away from the projection 340 until the magazine 308 is fully inserted.

Referring again to FIG. 11, the stapler 200 further includes a staple puller 344 located on the front side 208, near the top of the head 228. In the illustrated embodiment, the staple puller 344 is coupled to the bracket 300 and includes a claw shaped member 348 that can be used to pry a staple from a work-piece. In some embodiments, the front side 208 may be curved to provide a fulcrum for the staple puller 344. Alternatively, a fulcrum point can be provided by a protrusion on the front side 208.

In operation, the user grips the stapler 200 about the grip 236 and swings the stapler 200, similar to a hammer. When the shoe 244 contacts the workpiece, the shoe 244 actuates the firing mechanism 240 to drives a single staple into the work-piece. The magazine 308 advances the next staple into position to be driven. If necessary, the user may turn the stapler 200 upside down and strike the staple with the hammer surface 296 to further pound the staple into the workpiece. Additionally, if the user desires to remove the staple from the workpiece, the user can wedge the claw shaped member 348 of the staple puller 344 between the staple and the workpiece, and then pry the staple out of the work piece, using the front side 208 as a fulcrum.

One or more independent features of the invention are set forth in the following claims;

What is claimed is:

1. A stapler comprising:
a main body having a front side and a bottom side extending from the front side, a staple discharge opening being defined on the bottom side proximate the front side; and
a staple puller projecting from the front side.

2. The stapler of claim 1, wherein the front side has a curved shape to provide a fulcrum for the staple puller.

3. The stapler of claim 1, wherein the staple puller includes a generally claw-shaped member configured to pry a staple from a workpiece.

4. The stapler of claim 3, wherein the front side includes a resilient material to inhibit marring of the workpiece.

5. The stapler of claim 1, wherein the main body further includes a head and a handle extending from the head.

6. The stapler of claim 5, further comprising a shoe coupled to the head, wherein the stapler is configured to fire a staple through the discharge opening and into a workpiece when the shoe impacts the workpiece.

7. The stapler of claim 1, further comprising an actuating lever pivotally coupled to the main body, wherein the main body defines a grip aperture extending therethrough.

8. The stapler of claim 7, wherein the main body further has a back side opposite the front side, and wherein the grip aperture has an upper surface that angles upwardly in a direction from the front side to the back side.

9. The stapler of claim 1, further comprising a chamfer connecting the front side and the bottom side, the chamfer being located adjacent the staple discharge opening.

10. A stapler comprising:
a main body having a front side and a bottom side extending from the front side, a staple discharge opening being defined on the bottom side proximate the front side; and
a chamfer connecting the front side and the bottom side and located adjacent the staple discharge opening.

11. The stapler of claim 10, wherein the main body has a top side extending from the front side, and wherein the stapler further comprises an actuating lever pivotally coupled to the main body, the stapler being configured to fire a staple when the actuating lever is pivoted towards the top side.

12. The stapler of claim 10, wherein the main body defines a grip aperture extending therethrough.

13. The stapler of claim 12, wherein the main body has a back side opposite the front side, and wherein the grip aperture has an upper surface that angles upwardly in a direction from the front side to the back side.

14. The stapler of claim 10, further comprising a staple puller projecting from the front side.

15. The stapler of claim 10, wherein the main body has a back side opposite the front side, and wherein the stapler further comprises a hammer surface located on the back side.

16. A stapler comprising:
a main body having a front side, a back side and a bottom side extending between the front side and the back side, a staple discharge opening being defined on the bottom side proximate the front side; and
a hammer surface located on the back side.

17. The stapler of claim 16, wherein the hammer surface is made of metal.

18. The stapler of claim 17, wherein the main body includes a polymeric material.

19. The stapler of claim 16, further comprising an actuating lever pivotally coupled to the main body, wherein the main body defines a grip aperture extending therethrough.

20. The stapler of claim 19, wherein the grip aperture includes an upper surface that angles upwardly in a direction from the front side to the back side.
